(19) United States
(12) Patent Application Publication
(10) Pub. No.: US 2004/0167010 A1
(43) Pub. Date: Aug. 26, 2004

(54) Transparent ceramics and method for producing the same

(76) Inventors: Tatsuhiro Sato, Koriyama-shi (JP); Nobumasa Yoshida, Koriyama-shi (JP); Akira Fujinoki, Koriyama-shi (JP)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 10/474,217

(22) PCT Filed: Jan. 14, 2002
(86) PCT No.: PCT/EP02/00303

(30) Foreign Application Priority Data
Jan. 19, 2001 (JP) 2001-11923

(51) Int. Cl. C04B 35/505

(52) U.S. Cl. 501/152; 501/127

(57) ABSTRACT

An object of the present invention is to provide a transparent ceramics which exhibits favorable slope efficiency well comparable to that of a single crystal when employed in solid lasers, yet having a uniform quality and internally free from pores, foreign matters, or granular structures. Another object of the present invention is to provide a production method therefor. The above problems have been overcome by a transparent YAG—ceramics (YAG: Y₃Al₅O₁₂) the physical properties thereof is improved by doping a metallic element, provided that the concentration of the doped metallic elements is in a range of from 0.1 to 20% by weight, that the concentration of nitrogen is 500 ppm or lower, that said ceramics has pores and foreign matters accounting for less than 100 mm² per 100 cm³ as expressed by their projected area, and that it has an internal transmittance for visible radiations of 50 %/cm of higher. The metallic element for doping the YAG—ceramic is Nd.

### TECHNICAL FIELD OF THE INVENTION

The present invention relates to a transparent ceramics suitably used as a material for a solid laser utilized in medicals, marking of semiconductors, metal processing, etc., and to a method for producing the same.

### PRIOR ART

Solid lasers are used in medicals, marking of semiconductors, metal processing, and furthermore, as light sources for nuclear fusion and the like; thus, the field of their application and the field are steadily expanding. Solid lasers can be roughly classified into crystalline and amorphous (glass) lasers, however, the former, which are superior in thermal and mechanical characteristics, are only used in the industry.

Among the solid lasers, YAG (Y₃Al₅O₁₂) is superior from the viewpoint of overall characteristics, and so far this field depends on the present technique of growing single crystals, the possibility of discovering a new material superior than YAG is extremely low. Concerning industrial lasers, only YAG single crystals containing added therein Nd³⁺, which is the active ion relevant to the emission, account for most of the applications. Although Nd/YAG single crystals require one to three months for their growth, the portion usable as the laser medium is limited to a part of the ingot, and this has been found as a factor hindering the prevailed use of lasers due to the incompatibility in economically establishing high performance.

In the Nd/YAG single crystals, a core is detected at the central portion of the single crystal ingot, and facets (which are optically heterogeneous) extending from the center to the peripheral portions are found to be present. Since usable portions are only limited to the outer peripheral portions, the production yield is found to be extremely low. Furthermore, concerning the segregation coefficient of 0.2 for Nd in YAG, which signifies that Nd accounts for only about 1% by weight in the solid solution, there are disadvantages of low optical absorption coefficient and of causing concentration extinction (an extreme drop in fluorescence due to the interaction among the light-emitting ions). Hence, although Nd/YAG is inferior to none in the overall characteristics as a laser material, there still remain technical and economical problems above to be solved.

In the fabrication of an optical grade ceramics, there should be employed a powder starting material which easily sinters almost completely in the low temperature region to yield a dense body. In order to fabricate a transparent ceramics of a general use grade, there is employed a simple method comprising using a high quality powder starting material alone, in which sintering is applied thereto after adding a sintering aid for accelerating the densification. The transparent ceramics used to the present require that they simply have a function of transmitting light, however, in case of lasers, an extremely high quality is required to the material because optical amplification takes place within the medium. For instance, a slight distribution in refractive indices, a precipitation of a grain boundary phase, or residual pores inside the ceramics may lead to fatal effects such as a considerably high drop in laser emitting efficiency or an impaired beam quality. Hence, there is required to obtain ceramics having an ideal texture (i.e., a structure free from micro and macro defects).

In general, solid raw material is used in the production of ceramics. However, a solid raw material has poor pressure transmission, and tends to form fluctuation in quality due to the difference in pressure distribution between the outer peripheral portion and the inner portion within the molding. In order to compensate for such a heterogeneity in the packing of powder, forced removal of defects has been studied by using, for instance, an intermittent application of CIP (Cold Isostatic Pressing) or high-pressure sintering process such as HP (Hot Pressing), HIP (Hot Isostatic Pressing), etc., still, however, there generated a fluctuation in quality generated due to the difference in pressure distribution between the outer peripheral portion and the inner portion within the molding, or pores, foreign matters, and granular structures, tended to form inside the molding.

Problems the Invention is to Solve

The present invention has been made in the light of the aforementioned problems of the prior art technology, and an object of the present invention is to provide a transparent ceramics free from fluctuation in quality and containing no pores, foreign matters, and granular structures inside the structure, and thereby yields a favorable slope efficiency well comparable to that of a single crystal when used in a solid laser. Another object of the present invention is to provide a method for producing the same.

Means for Solving the Problems

In order to solve the problems above, the present invention provides a transparent ceramics the physical properties thereof is improved by doping a metallic element, provided that the concentration of the doped metallic elements is in a range of from 0.1 to 20% by weight, that the concentration of nitrogen is 500 ppm or lower, that said ceramics has pores and foreign matters accounting for less than 100 mm² per 100 cm³ as expressed by their projected area, and that it has an internal transmittance for visible radiations of 50%/cm or higher.

Preferably, the OH concentration of the transparent ceramics body above is 100 ppm or lower, and the ceramics body contains no granular structure. As the doped metallic element is preferably Nd, and said ceramics is preferably YAG. The transparent ceramics is favorably used for a solid laser.

The method for producing a transparent ceramics according to the present invention is characterized by that it comprises preparing a slurry by mixing and dissolving a nitrate compound of a metallic element, a dispersant, and a ceramic powder in pure water; applying an organic matter removal treatment, a nitrogen removal treatment, and a dehydroxylation treatment after drying and solidifying said slurry; and then heating and fusing the resulting product in vacuum, an inert gas atmosphere, or in a gaseous hydrogen atmosphere.

The removal of organic matter above can be performed by holding a dried slurry body under a gaseous atmosphere containing oxygen, and at a temperature in a range of, for instance, from 200° C. to 1000° C. The treatment requires a processing time of 30 minutes or longer, and preferably, 2 hours or longer.

The nitrogen removal treatment comprises holding the dried slurry body in the temperature range of from 150 to 1400° C. in a gaseous hydrogen atmosphere or in a gaseous atmosphere containing oxygen. The treatment requires a processing time of 30 minutes or longer, and preferably, 2 hours or longer.

The dehydroxylation treatment comprises holding the dried slurry body in the temperature range of from 400 to 1400° C. in a gaseous atmosphere containing Cl. The treatment requires a processing time of 30 minutes or longer, and preferably, 2 hours or longer.

After performing the treatments above, heating and fusing is applied in order to obtain a transparent dried body. The atmosphere for use in this step is as described hereinabove; concerning the heating conditions, heating is performed at a temperature not lower than 1500° C. or lower, particularly preferably, in a range of from 1750° C. to 1850° C., and a transparent body can be efficiently obtained by holding in the temperature range above for a duration of 30 minutes or longer.

The granularity of the ceramic powder is preferably in a range of from 0.01 to 50 μm. Most preferably, the metallic element is Nd, and the ceramics powder consists of YAG particles.

The metallic element above must be uniformly doped in the ceramic body. The metallic element to be doped is a lanthanide represented by Nd and Sm, and the transparent body obtained as a result is used in a solid laser and the like.

Selected as a means of doping the metallic elements above is such comprising preparing a slurry by mixing and dissolving in pure water, a dispersant, which is an organic material, with a nitrate compound containing the desired metal and a ceramic powder; drying, and then heat treating the product in an atmosphere containing oxygen in a temperature range of from 150° C. to 1400° C.; and heating for fusion. The reason for using a nitrate compound for doping a metal is, because nitrate compounds easily dissolve in pure water, and because it can be most easily handled.

Furthermore, oxides are sparingly soluble and cannot be dispersed and mixed in the molecular level. Hence, since they cannot be uniformly dispersed and mixed, the resulting product tends to cause whitening, or the generation of bubbles and foreign matters after the vitrification treatment. Although nitrogen remains from a nitrate compound as to cause bubbles, nitrogen can be easily removed by oxidation and gasification together with the organic materials added as the dispersant. As the gas, preferred is to use O₂, air, etc.

Nitrogen can be removed otherwise in the form of gaseous NH₃ by reacting it with NH₃ or H₂. The treatment is preferably performed in the temperature range of from 150° C. to 1400° C. At a temperature lower than 150° C., the reaction would not take place, and at a temperature higher than 1400° C., sintering proceeds on the dried body as to make degassing impossible, thereby remaining pores in the sintered body. Furthermore, water remaining in the dried body must be completely removed. Water remaining in the body causes absorption scattering of the laser beams. Both of the treatments above must be performed for a duration of 30 minutes or longer, and more preferably, 2 hours or longer.

Concerning other factors, the presence of a granular structure also greatly affects the absorption scattering. As a means for coping with this problem, the granularity of the ceramic powder is reduced to fall in a limited range of from 0.01 to 50 μm, such that the fluctuation in the concentration of metallic elements is minimized to suppress the fluctuation in refractive index, and that the granular structure should be thereby avoided. A product with high transparency can be obtained by heating and fusing the dry body in vacuum, an inert gas atmosphere, or in gaseous hydrogen.

The transparent body obtained as a result was found to contain pores and foreign matters at an amount accounting for less than 100 mm² per 100 cm³ as expressed by their projected area, and to have an internal transmittance for visible radiations of 50%/cm or higher. Concerning the concentration of the doped metallic element, it has been found that sufficient radiation efficiency cannot be obtained at a concentration of lower than 0.1 wt. %, and that the generation of pores and foreign matters could not be prevented at a concentration exceeding 20 wt. %.

### EXAMPLES

The present invention is explained by way of examples below, but it should be understood that the present invention should not be limited thereby.

### Example 1

Slurry was prepared by mixing 750 g of YAG particles 0.1 to 30 μm in particle diameter, 20 g of an amphoteric surface activating agent, 600 g of neodymium nitrate, and 1500 g of pure water. The slurry was dried in air at 40° C. for 8 days to obtain a solid body, and after holding it under an atmosphere containing 50% of oxygen and 50% of nitrogen at 500° C. for 4 hours, it was kept under an atmosphere containing 50% of Cl₂ and 50% of nitrogen at 800° C. for 4 hours.

Then, the solid body thus obtained was thermally treated at 1800° C. for one hour under vacuum to obtain a transparent glass body 80 mm in diameter and 30 mm in thickness. The transparent body was found to contain pores and foreign matters accounting for 20 mm² per 100 cm³ as expressed by their projected area, and to yield an internal transmittance for visible radiations of 80%/cm.

The glass body was found to have contain N at a concentration of 50 ppm and OH at a concentration of 30 ppm. On measuring the Nd concentration by means of fluorescent X ray analysis, a value of 3.0 wt. % was obtained. On exciting the sample thus obtained with a semiconductor laser emitting a radiation of 808 nm in wavelength, a slope efficiency (i.e., a conversion efficiency after emitting a laser radiation) of 25%, a value well comparable to that of a single crystal, was obtained.

### Comparative Example 1

A 750-g portion of YAG particles 0.1 to 30 μm in particle diameter was mixed with 20 g of an amphoteric surface activating agent and 600 g of neodymium nitrate. The resulting mixture was held under an atmosphere consisting of 50% oxygen and 50% nitrogen at 500° C. for 4 hours, and was subjected to heating for fusion at 1800° C. under vacuum. Thus was obtained an opaque glass body 80 mm in diameter and 30 mm in thickness.

The OH concentration of the glass body was found to be 300 ppm. On measuring the Nd concentration by means of fluorescent X ray analysis, a value of 3.0 wt. % was obtained. On exciting the sample thus obtained with a semiconductor laser emitting a radiation of 808 nm in wavelength, it was found to yield a slope efficiency (i.e., a conversion efficiency after emitting a laser radiation) of 1%.

### Comparative Example 2

A slurry was prepared by mixing 750 g of YAG particles 0.1 to 30 μm in particle diameter, 20 g of an amphoteric surface activating agent, 600 g of neodymium nitrate, and 1500 g of pure water. After drying the slurry in air at 40° C. for 8 days to obtain a solid body, it was subjected to a heat treatment at 1800° C. for 1 HR under vacuum.

The solid body thus obtained was found to contain numerous pores, and an OH concentration of 300 ppm was obtained on a sample cut out from the solid body. On measuring the Nd concentration by means of fluorescent X ray analysis, a value of 3.0 wt. % was obtained. On exciting the sample thus obtained with a semiconductor laser emitting a radiation of 808 nm in wavelength, it was found to yield a slope efficiency (i.e., a conversion efficiency after emitting a laser radiation) of 1%.

### Comparative Example 3

A slurry was prepared by mixing 750 g of YAG particles 0.1 to 5 μm in particle diameter, 20 g of an amphoteric surface activating agent, 4500 g of neodymium nitrate, and 13500 g of pure water. After drying the slurry in air at 40° C. for 8 days to obtain a solid body, the resulting body was held under an atmosphere containing 50% of oxygen and 50% of nitrogen at 500° C. for 4 hours, and then under an atmosphere containing 50% of Cl₂ and 50% of nitrogen at 800° C. for 4 hours.

Then, the solid thus obtained was subjected to a heat treatment at 1800° C. for one hour under vacuum to obtain a transparent glass body 80 mm in diameter and 30 mm in thickness. The resulting glass body was found to contain numerous pores and foreign matters. The concentration for N and OH of the glass body were found to be 50 ppm and 30 ppm, respectively. On measuring the Nd concentration by means of fluorescent X ray analysis, a value of 21.0 wt. % was obtained. On exciting the sample thus obtained with a semiconductor laser emitting a radiation of 808 nm in wavelength, it was found to yield a slope efficiency (i.e., a conversion efficiency after emitting a laser radiation) of 1%.

Effect of the Invention

As described above, the transparent ceramics according to the present invention was found to have no fluctuation in quality and free from internal pores and foreign matters, and that it is effective in that it exhibits favorable slope efficiency well comparable to that of a single crystal when used as a solid laser. In accordance with the production method of the present invention, it enables efficient production of a transparent ceramics according to the present invention.

1) A transparent ceramics the physical properties thereof is improved by doping a metallic element, provided that the concentration of the doped metallic elements is in a range of from 0.1 to 20% by weight, that the concentration of nitrogen is 500 ppm or lower, that said ceramics has pores and foreign matters accounting for less than 100 mm² per 100 cm³ as expressed by their projected area, and that it has an internal transmittance for visible radiations of 50%/cm or higher.

2) A transparent ceramics as claimed in claim 1, wherein said ceramics body has an OH concentration of 100 ppm or lower.

3) A transparent ceramics as claimed in claim 1 or 2, wherein said ceramics body contains no granular structure.

4) A transparent ceramics as claimed in one of claims 1 to 3, wherein the doped metallic element is Nd, and said ceramics is YAG (Y₃Al₅O₁₂).

5) A transparent ceramics as claimed in one of claims 1 to 4, which is used for a solid laser.

6) A method for producing a transparent ceramics, comprising preparing a slurry by mixing and dissolving a nitrate compound of a metallic element, a dispersant, and a ceramic powder in pure water; applying an organic matter removal treatment, a nitrogen removal treatment, and a dehydroxylation treatment after drying and solidifying said slurry; and then heating and fusing the resulting product in vacuum, an inert gas atmosphere, or in a gaseous hydrogen atmosphere.

7) A method for producing a transparent ceramics as claimed in claim 6, wherein the nitrogen removal treatment comprises holding the dried slurry body in the temperature range of from 150 to 1400° C. in a gaseous hydrogen atmosphere or in a gaseous atmosphere containing oxygen.

8) A method for producing a transparent ceramics as claimed in claim 6 or 7, wherein the dehydroxylation treatment comprises holding the dried slurry body in the temperature range of from 400 to 1400° C. in a gaseous atmosphere containing Cl.

9) A method for producing a transparent ceramics as claimed in one of claims 6 to 8, wherein the ceramics powder has granularity in a range of from 0.01 to 50 μm.

10) A method for producing a transparent ceramics as claimed in one of claims 6 to 9, wherein the metallic element is Nd and the ceramics powder consists of YAG particles.
